(19) United States
(12) Patent Application Publication
(10) Pub. No.: US 2026/0089793 A1
(43) Pub. Date: Mar. 26, 2026

(54) SIGNALING TO INFORM A NETWORK NODE A USER EQUIPMENT-TO-USER EQUIPMENT LINK BETWEEN A REMOTE USER EQUIPMENT AND A RELAY USER EQUIPMENT

(71) Applicant: QUALCOMM Incorporated, San Diego, CA (US)

(72) Inventors: Jianhua LIU, Beijing (CN); Karthika PALADUGU, Hyderabad (IN); Hong CHENG, Basking Ridge, NJ (US); Ozcan OZTURK, San Diego, CA (US); Shankar KRISHNAN, Poway, CA (US)

(21) Appl. No.: 19/112,909

(22) PCT Filed: Nov. 4, 2022
(86) PCT No.: PCT/CN2022/129984

§ 371 Date: Mar. 18, 2025

(51) Int. Cl. H04W 76/27; H04W 72/25; H04W 88/04

(52) U.S. Cl. CPC H04W 76/27; H04W 72/25; H04W 88/04

(57) ABSTRACT

A UE transmits UE to UE (UE-UE) link information indicating a UE-UE link type between a remote user equipment (UE) and a relay UE, the first UE being one of the remote UE or the relay UE. The UE also receives a configuration corresponding to the transmitted UE-UE link information.

### TECHNICAL FIELD

The present disclosure relates generally to communication systems, and more particularly, to wireless communications utilizing multipath relay.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include memory; and at least one processor coupled to the memory and configured to: transmit user equipment (UE) to UE (UE-UE) link information indicating a UE-UE link type between a remote user equipment (UE) and a relay UE, the first UE being one of the remote UE or the relay UE; and receive a configuration corresponding to the transmitted UE-UE link information.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a first configuration of multipath relay.

FIG. 4B is a diagram illustrating a second configuration of multipath relay.

FIG. 5A is a diagram illustrating a control plane for a Layer-2 UE-to-Network Relay protocol stack.

FIG. 5B is a diagram illustrating a user plane for a Layer-2 UE-to-Network Relay protocol stack.

FIG. 6A is a diagram illustrating a first user plane architecture configuration.

FIG. 6B is a diagram illustrating a second user plane architecture configuration.

FIG. 7 is a call flow diagram illustrating a method of wireless communication in accordance with various aspects of this present disclosure.

FIG. 8 is a call flow diagram illustrating a method of wireless communication in accordance with various aspects of this present disclosure.

FIG. 9 is a call flow diagram illustrating a method of wireless communication in accordance with various aspects of this present disclosure.

FIG. 10 is a call flow diagram illustrating a method of wireless communication in accordance with various aspects of this present disclosure.

FIG. 11 is a flowchart illustrating methods of wireless communication at a UE in accordance with various aspects of the present disclosure.

FIG. 12 is a flowchart illustrating methods of wireless communication at a network node in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

Multipath (MP) relay enables a UE (e.g., a remote UE) to be connected to the same network node via multiple paths (e.g., via a direct path to the network node and an indirect path to the network node via a relay UE). By doing so, the reliability and the throughput of the connection to the network node may be enhanced (e.g., by switching among or utilizing multiple paths simultaneously). However, the effectiveness of MP relay depends on the manner in which the UE is configured, as a UE may be configured differently depending on the link type by which the UE is connected to the other UE. Aspects presented herein provide for methods and apparatus for a remote UE or a relay UE to inform a network node of the UE-UE link type being utilized between a remote UE and a relay UE. Using the UE-UE link type, the network node determines a configuration for the remote UE and the relay UE corresponding to the UE-UE link type and provides the determined configuration to the remote UE and the relay UE. The remote UE and the relay UE apply the configuration received from the network node. In some aspects, the UE may transmit UE-UE link information indicating a UE-UE link type between a remote UE and a relay UE, the first UE being one of the remote UE or the relay UE. The UE may also receive a configuration corresponding to the transmitted UE-UE link information. The methods and apparatus advantageously enable a network node to correctly configure a remote UE and a relay UE for MP relay, thereby enhancing the reliability and throughput of the connection between the UEs and the network node.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

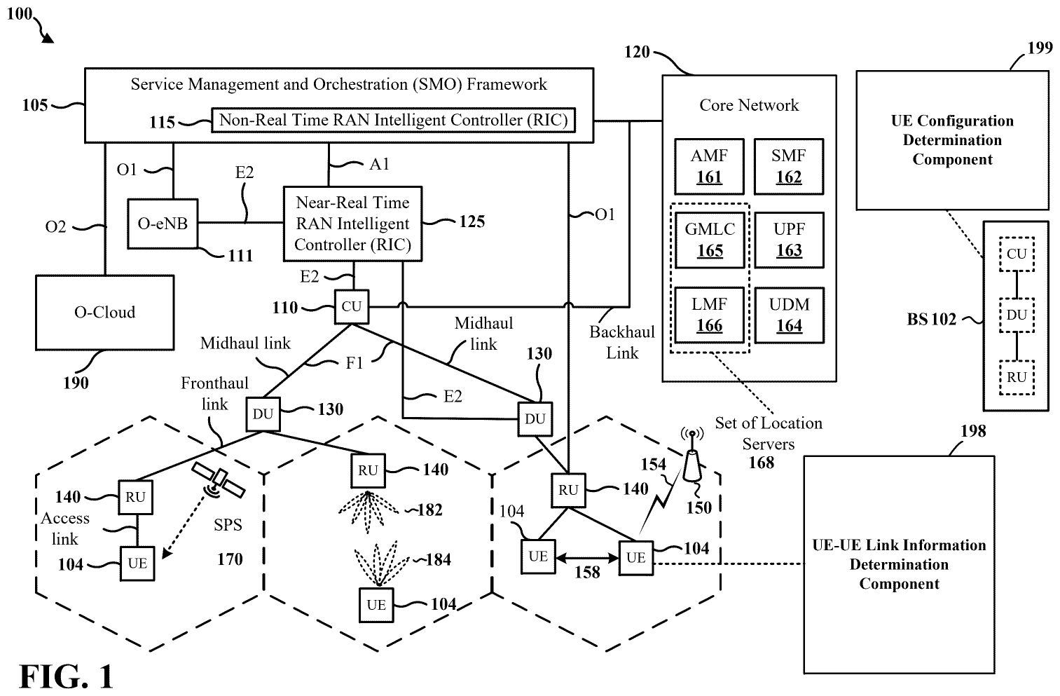

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to include a UE to UE (UE-UE) link information determination component 198 configured to transmit UE-UE link information indicating a UE-UE link type between a remote UE and a relay UE, the first UE being one of the remote UE or the relay UE. The UE-UE link information determination component 198 may be also configured to receive a configuration corresponding to the transmitted UE-UE link information. In certain aspects, the base station 102 may be configured to include a UE configuration determination component 199 configured to receive UE-UE link information indicating a UE-UE link type between a remote UE and a relay UE. The UE configuration determination component 199 may be also configured to transmit a configuration to the remote UE and the relay UE corresponding to the received UE-UE link information. Although the following description may be focused on 5G NR, the concepts described herein may be applicable to other similar areas, such as LTE, LTE-A, CDMA, GSM, and other wireless technologies.

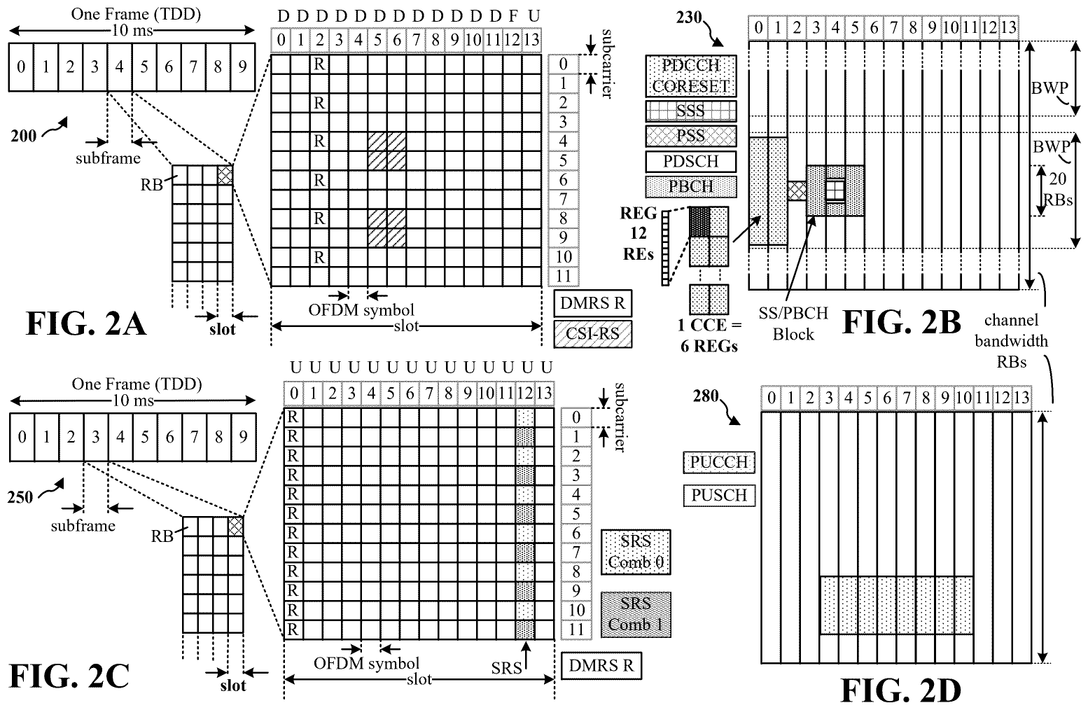

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

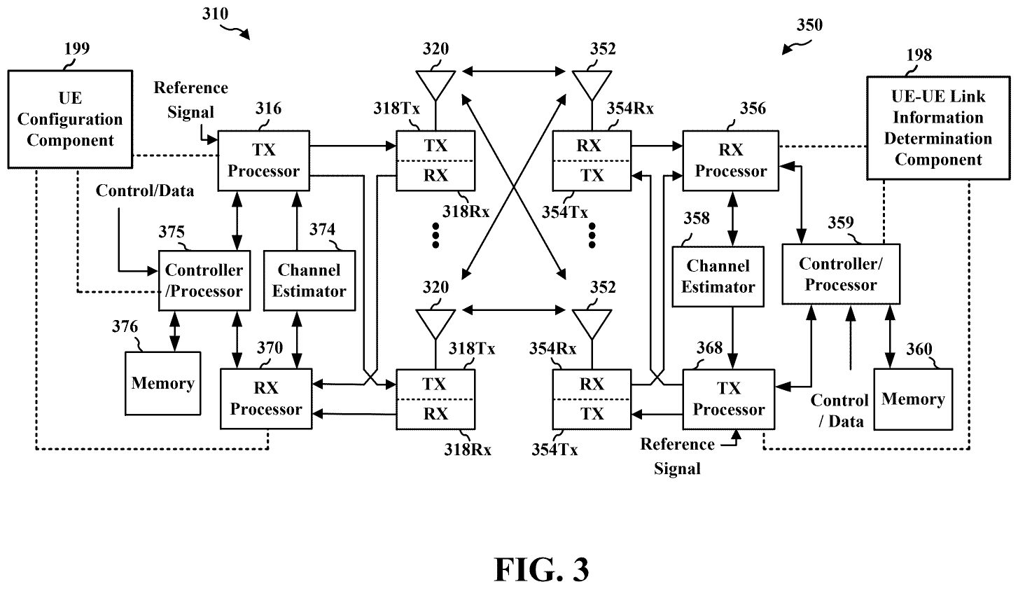

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE-UE link information determination component 198 of FIG. 1. At least one of the TX processor 316, the RX processor 370, and the controller/processor 375 may be configured to perform aspects in connection with the UE configuration determination component 199 of FIG. 1.

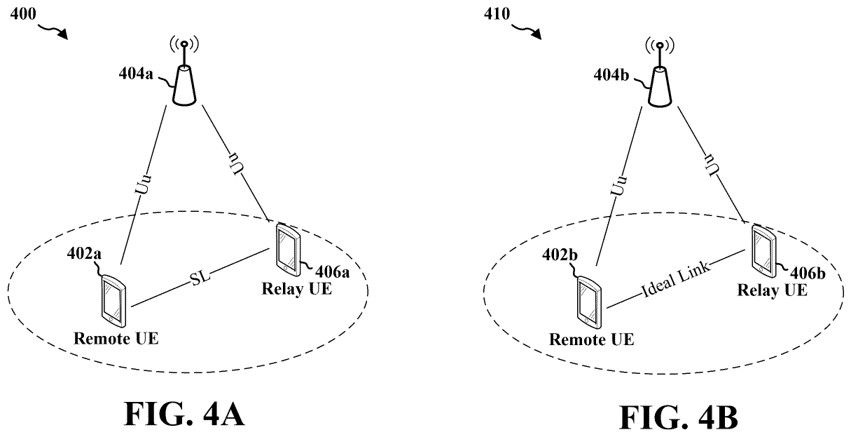

MP relay enables a UE to be connected to the same network node via multiple paths. By doing so, the reliability and the throughput of the connection to the network node may be enhanced (e.g., by switching among or utilizing multiple paths simultaneously). FIGS. 4A and 4B illustrate various configurations of MP relay. In particular, FIG. 4A shows a first configuration 400 of MP relay, where a remote UE 402a is connected to the same network node 404a using a direct path and an indirect path via a Layer-2 (L2) UE-to-Network relay. In this example, the remote UE 402a is connected to the network node 404a via a direct path using a UE-UTRAN (Uu) interface and is indirectly connected to the network node 404a via a relay UE 406a. As shown in FIG. 4A, the remote UE 402a is connected to the relay UE 406a via a sidelink interface (e.g., PC5), and the relay UE 406a is connected to the network node 404a via a Uu interface.

FIG. 4B shows a second configuration 410 of MP relay, where a remote UE 402b is connected to the same network node 404b using a direct path and an indirect path via another UE (where the UE-UE inter-connection is assumed to be ideal). In this example, the remote UE 402b is connected to the network node 404b via a direct path using a Uu interface and is indirectly connected to the network node 404b via a relay UE 406b. As shown in FIG. 4B, the remote UE 402b is connected to the relay UE 406a via an ideal link (e.g., a link that is outside the scope of (or not defined by) 3GPP), and the relay UE 406b is connected to the network node 404b via a Uu interface. The relation between the remote UE 402b and the relay UE 406b may be pre-configured or static, and how the relation is pre-configured or static is out of the scope of 3GPP.

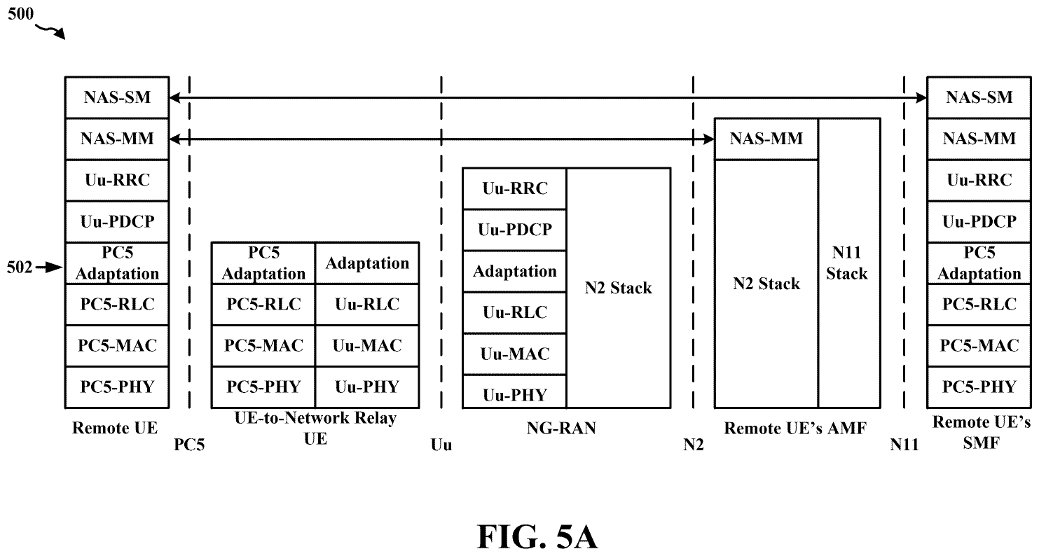

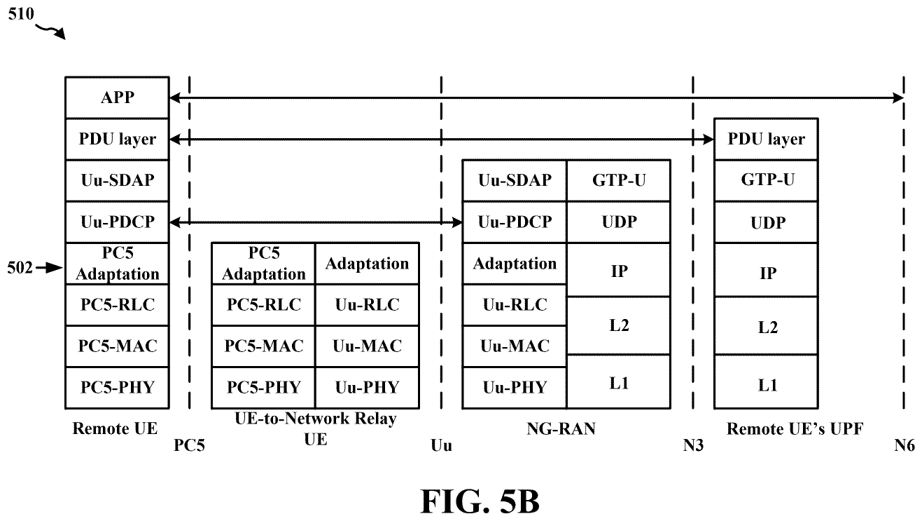

FIGS. 5A and 5B are diagrams illustrating a Layer-2 UE-to-Network Relay protocol stack. In particular, FIG. 5A is a diagram 500 illustrating a control plane for Layer-2 UE-to-Network Relay. FIG. 5B is a diagram 510 illustrating a user plane for Layer-2 UE-to-Network Relay. As shown in FIGS. 5A and 5B, a PC5 adaptation layer 502 is introduced. It is noted that a PC5-S/PC5-RRC connection (not shown) may be between the remote UE and the relay UE.

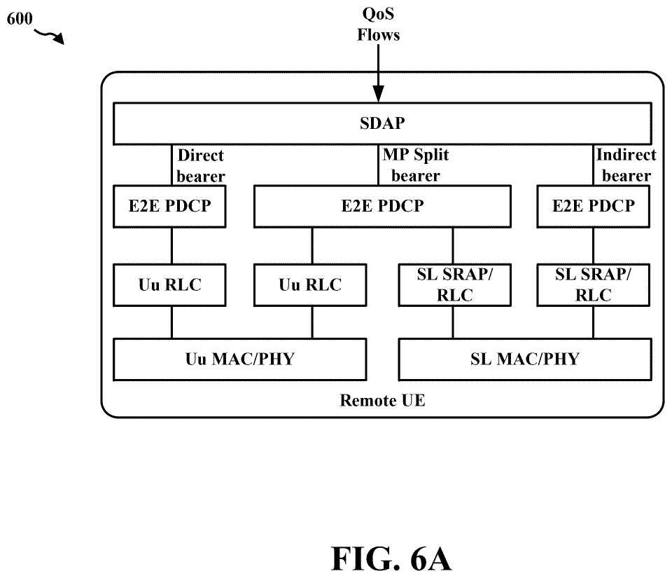

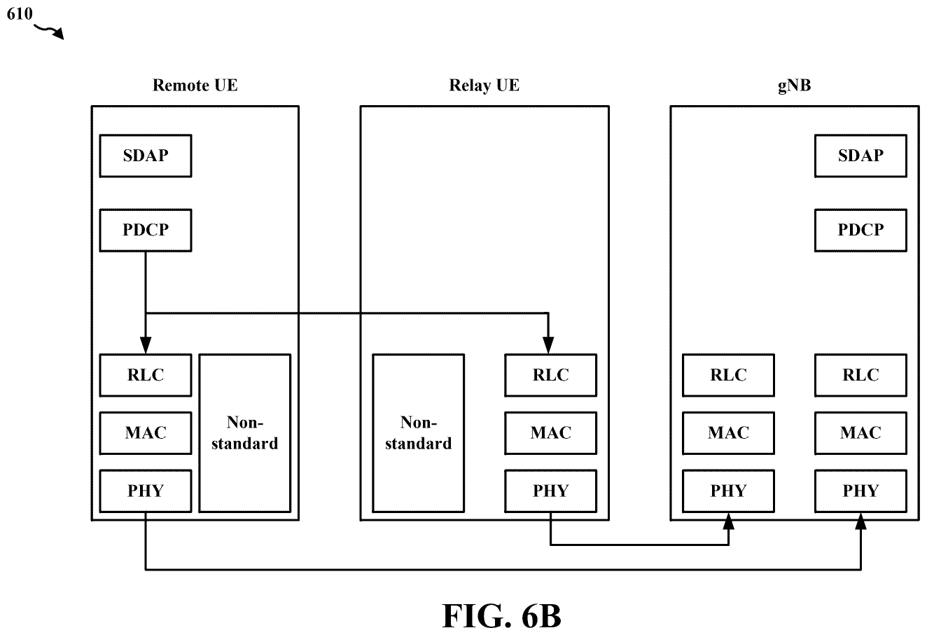

The user plane architecture for a UE may vary depending on the UE-UE link type. For example, FIG. 6A is a diagram 600 illustrating a first user plane architecture configuration in which a remote UE is indirectly connected to a network node via a Layer-2 UE-to-Network relay, where the UE-UE connection is a sidelink connection (as described above with reference to FIG. 4A). FIG. 6B is a diagram 610 illustrating a second user plane architecture configuration in which a remote UE is indirectly connected to a network node via another UE, where the UE-UE connection is an ideal link (as described above with reference to FIG. 4B).

As shown in FIG. 6A, the first user plane architecture includes a sidelink relay adaptation protocol (SRAP)-based adaptation layer, which is used to identify which remote UE, bearer, and/or logical channel should be used. When the UE-UE connection is a sidelink layer, the network node configures the SRAP layer to enable communication via the Uu interface and the sidelink (e.g., PC5) interface. When the UE-UE connection is an ideal link, the network node does not provide and/or configure the SRAP adaptation layer for the remote UE and the relay UE via the Uu interface or the ideal link. Instead, the network node may assume a relay UE services one remote UE and that the bearer-to-logical channel mapping is a one-to-one mapping (i.e., one logical channel is mapped to and used to identify one radio bearer). Accordingly, there is a difference in network node behavior based on which UE-UE link type between the remote UE and the relay UE. However, there are no conventional mechanisms for the network node to be aware of the UE-UE link type.

Aspects of the present disclosure provide for methods and apparatus for a remote UE or a relay UE to inform a network node of the UE-UE link type being utilized between a remote UE and a relay UE. Using the UE-UE link type, the network node may determine a configuration for the remote UE and the relay UE corresponding to the UE-UE link type and may provide the determined configuration to the remote UE and the relay UE. The remote UE and the relay UE may apply the configuration received from the network node. The methods and apparatus of aspects of the present disclosure may advantageously enable a network node to correctly configure a remote UE and a relay UE for MP relay, thereby enhancing the reliability and throughput of the connection between the UEs and the network node.

In one aspect, the remote UE may inform the network node the UE-UE link type using an RRC message, and the network node may provide appropriate configuration to the remote UE and the relay UE. In accordance with such an aspect, the remote UE may inform the network node the UE-UE link type information using a sidelink UE information NR message (e.g., SidelinkUEInformationNR) or measurement report (also referred to as a MeasurementReport), or a message 5 (MSG5) message (also referred to msg5 or message 5). The sidelink UE information NR message may be an RRC message. The MSG5 message may be an RRCSetupComplete message, an RRCResumeComplete message, or an RRCReconfigurationComplete message. Utilizing an MSG5 message allows the network node to provide appropriate configuration after RRC setup, RRC resume, or a handover procedure. The UE-UE link type information may include at least one of the following information (e.g., associated with a connection between the remote UE and the relay UE): sidelink connection information, PC5 interface information, 3GPP connection information, non-3GPP connection information, ideal link information, UE aggregation information, L2 relay connection information, WLAN connection information, Bluetooth connection information, etc.

The remote UE may determine the UE-UE link type according to the following information: whether the remote UE supports the corresponding UE-UE link type, whether the remote UE supports MP relay for the corresponding UE-UE link type, whether the remote UE is subscribed and/or authorized with the corresponding UE-UE link type, whether the remote UE is subscribed and/or authorized with MP relay for the corresponding UE-UE link type, whether the remote UE discovers or is pre-configured or is connected with one relay UE using the corresponding UE-UE link type, etc.

When the remote UE detects the UE-UE link is available for connection with the network node, the remote UE may include the UE-UE link type in an RRC message (e.g., a sidelink UE information NR message) or measurement report. The remote UE may detect a UE-UE link is available according to the following: the UE-UE link quality satisfies the criterion configured by the network for single path relay, the UE-UE link quality satisfies the criterion configured by the network for MP relay, the UE-UE link is available based on UE implementation (e.g., the capabilities of the UE), etc.

In another aspect, the relay UE may inform the network node the UE-UE link type using an RRC message, and the network node may provide appropriate configuration to the remote UE and the relay UE. In accordance with such an aspect, the relay UE may inform the network node the UE-UE link type information using a sidelink UE information NR message (e.g., SidelinkUElnformationNR), measurement report (also referred to as a MeasurementReport), or an MSG5 message (also referred to a msg5 or message 5). The sidelink UE information NR message may be an RRC message. The MSG5 message may be an RRCSetupComplete message, an RRCResumeComplete message, or an RRCReconfigurationComplete message. Utilizing an MSG5 message allows the network node to provide appropriate configuration after RRC setup, RRC resume, or a handover procedure. The UE-UE link type information may include at least one of the following information (e.g., associated with a connection between the remote UE and the relay UE): sidelink connection information, PC5 interface information, 3GPP connection information, non-3GPP connection information, ideal link information, UE aggregation information, L2 relay connection information, WLAN connection information, Bluetooth connection information, etc.

The relay UE may determine the UE-UE link type according to the following information: whether the relay UE supports the corresponding UE-UE link type, whether the relay UE is subscribed and/or authorized with the corresponding UE-UE link type, whether the relay UE discovers or is pre-configured or is connected with one remote UE using the corresponding UE-UE link type, etc.

When the relay UE detects the UE-UE link is available for connection with the network node, the relay UE may include the UE-UE link type in an RRC message (e.g., a sidelink UE information NR message) or measurement (e.g., a measurement report). The relay UE may detect a UE-UE link is available according to the following: the UE-UE link quality satisfies the criterion configured by the network, the UE-UE link is available based on UE implementation (e.g., the capabilities of the UE), etc.

In a further aspect, the core network (CN) may inform the network node the UE-UE link type using a next generation application protocol (NGAP) message, and the network node may provide the appropriate configuration to the remote UE and the relay UE. In accordance with such an aspect, the CN may inform the network node the UE-UE link type information using UE initial context in NGAP (e.g., the authorized UE-UE link type). The CN may obtain the UE-UE link type information according to the following: remote UE and/or relay UE's subscription information (e.g., whether the remote and/or relay UE is subscribed with the corresponding UE-UE link type) or by the remote UE and/or the relay UE informing the CN via a non-access stratum (NAS) message.

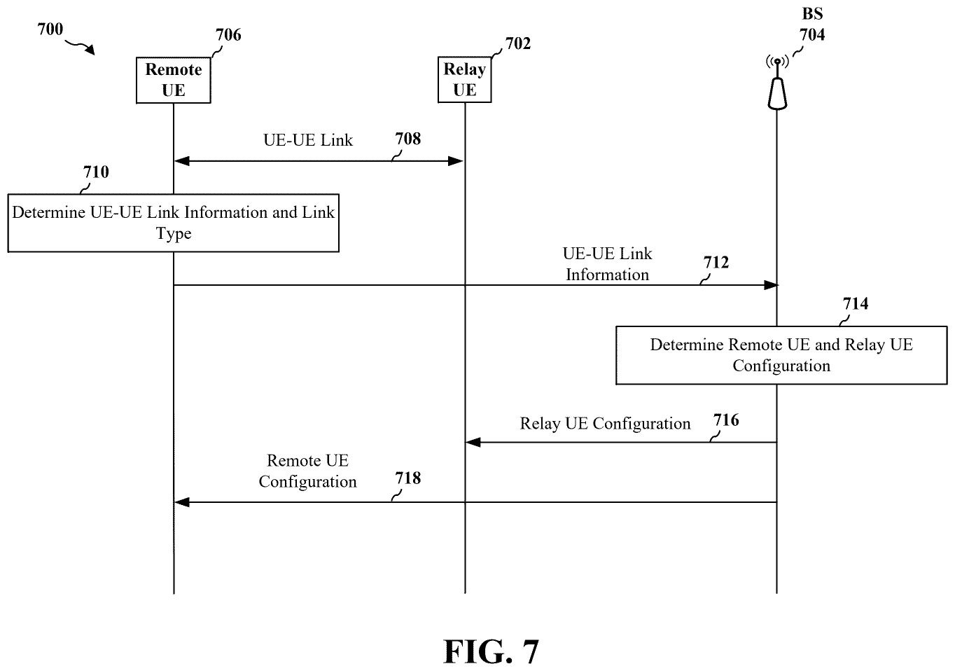

FIG. 7 is a call flow diagram 700 illustrating a method of wireless communication in accordance with various aspects of the present disclosure. In particular, call flow diagram 700 illustrates a remote UE 706 informing a network node 704 information associated with a UE-UE link 708 between the remote UE 706 and a relay UE 702. The relay UE 702 may be a UE that relays data from the network node 704 to another UE (e.g., a UE that is outside the coverage area of the network node 704). The remote UE 706 may be a UE that receives data from another UE (e.g., the relay UE 702) and/or the network node 704 (depending on whether the remote UE 706 is within the coverage area of the network node 704). Although aspects are described for the network node 704, the aspects may be performed by a network node in aggregation and/or by one or more components of a network node 704 (e.g., such as a CU 110, a DU 130, and/or an RU 140). As shown in FIG. 7, the remote UE 706 may, at 710, determine UE-UE link information indicating a UE-UE link type (e.g., for UE-UE link 708) between the remote UE 706 and the relay UE 702. The UE-UE link information may indicate various information associated with the link between the relay UE 702 and the remote UE 706. For instance, the UE-UE link information may indicate the type of UE-UE link established between the relay UE 702 and the remote UE 706.

In one aspect, the remote UE 706 may determine the UE-UE link type based on at least one of whether the remote UE 706 supports a corresponding UE-UE link type, whether the remote UE 706 supports an MP relay for a corresponding UE-UE link type, whether the remote UE 706 is subscribed or authorized with a corresponding UE-UE link type, whether the remote UE 706 is subscribed or authorized with an MP relay for a corresponding UE-UE link type, or whether the remote UE 706 discovers, is pre-configured, or is connected with the relay UE 702 through a corresponding UE-UE link type.

In one aspect, the remote UE 706 may detect UE-UE link type(s) available between the remote UE 706 and the relay UE 702 based on at least one of whether a UE-UE link quality for a UE-UE link type satisfies a criterion configured for single path relay, whether a UE-UE link quality for a UE-UE link type satisfies a criterion configured for MP relay, or whether a UE-UE link for a UE-UE link type is available based on a capability of the remote UE 706.

At 712, the remote UE 706 provides the UE-UE link information to the network node 704. In one aspect, the UE-UE link information is transmitted through an RRC message. In another aspect, the UE-UE link information is transmitted in a sidelink UE NR message, a measurement report, or an MSG5 message.

In one aspect, the detected UE-UE link type(s) described above are indicated in the UE-UE link information transmitted to the network node 704 at 712.

In one aspect, the UE-UE link information transmitted at 712 may include information associated with at least one of a sidelink connection, a PC5 interface, a 3GPP connection, a non-3GPP connection, an ideal link, a UE aggregation connection, an L2 relay connection, a WLAN connection, or a Bluetooth connection between the remote UE 706 and the relay UE 702.

At 714, the network node 704 determines a configuration for the remote UE 706 and the relay UE 702 based on (e.g., corresponding to) the UE-UE link information received at 712. For example, the configuration may be in accordance with the user plane architecture configuration described above with reference to 6A or the user plane architecture configuration described above with reference to 6B depending on the determined UE-UE link type of UE-UE link 708.

At 716, the network node may provide (e.g., transmits) the configuration determined for the relay UE 702 to the relay UE 702. At 718, the network node 704 may provide the configuration determined for the remote UE 706 to the remote UE 706. It is noted that the network node 704 may transmit the configuration for the relay UE 702 before, after, or simultaneous with transmitting the configuration for the remote UE 706.

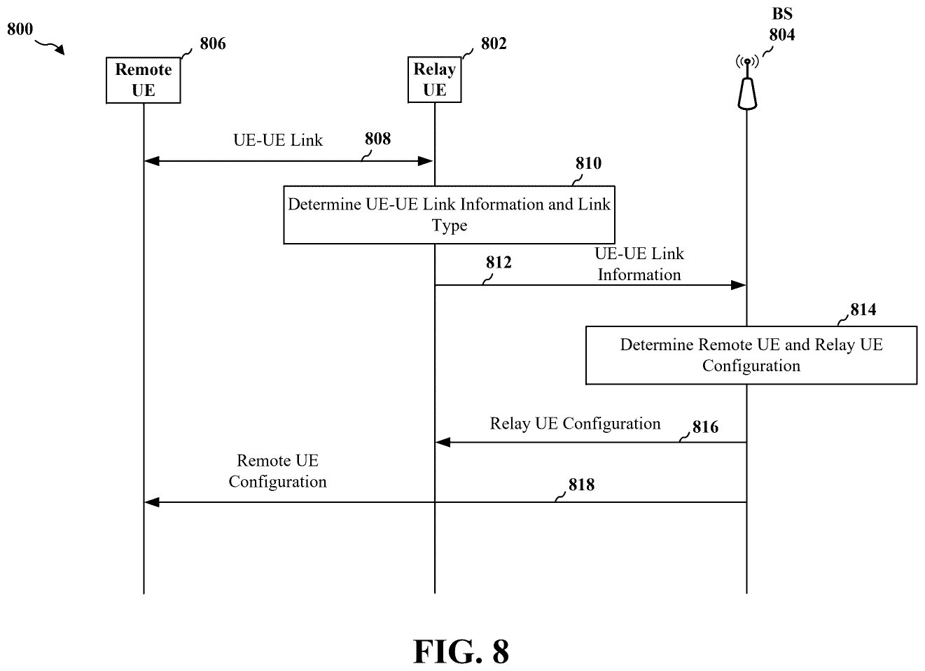

FIG. 8 is a call flow diagram 800 illustrating a method of wireless communication in accordance with various aspects of the present disclosure. In particular, call flow diagram 800 illustrates a relay UE 802 informing a network node 804 information associated with a UE-UE link 808 between a remote UE 806 and the relay UE 802. The relay UE 802 may be a UE that relays data from the network node 804 to another UE (e.g., a UE that is outside the coverage area of the network node 804). The remote UE 806 may be a UE that receives data from another UE (e.g., the relay UE 802) and/or the network node 804 (depending on whether the remote UE 806 is within the coverage area of the network node 804). Although aspects are described for the network node 804, the aspects may be performed by a network node in aggregation and/or by one or more components of a network node 804 (e.g., such as a CU 110, a DU 130, and/or an RU 140). As shown in FIG. 8, the relay UE 802 may, at 810, determine UE-UE link information indicating a UE-UE link type (e.g., for UE-UE link 808) between the remote UE 806 and the relay UE 802. The UE-UE link information may indicate various information associated with the link between the relay UE 802 and the remote UE 806. For instance, the UE-UE link information may indicate the type of UE-UE link established between the relay UE 802 and the remote UE 806.

In one aspect, the relay UE 802 may determine the UE-UE link type based on at least one of whether the relay UE 802 supports a corresponding UE-UE link type, whether the relay UE 802 is subscribed or authorized with a corresponding UE-UE link type, or whether the relay UE 802 discovers, is pre-configured, or is connected with the remote UE 806 through a corresponding UE-UE link type.

In one aspect, the relay UE 802 may detect UE-UE link type(s) available between the remote UE 806 and the relay UE 802 based on at least one of whether a UE-UE link quality for a UE-UE link type satisfies a criterion, or whether a UE-UE link for a UE-UE link type is available based on a capability of the relay UE 802.

At 812, the relay UE 802 may provide the UE-UE link information to the network node 804. In one aspect, the UE-UE link information is transmitted through an RRC message. In another aspect, the UE-UE link information is transmitted in a sidelink UE NR message, a measurement report, or an MSG5 message.

In one aspect, the detected UE-UE link type(s) described above are indicated in the UE-UE link information transmitted to the network node 804 at 812.

In one aspect, the UE-UE link information transmitted at 812 may include information associated with at least one of a sidelink connection, a PC5 interface, a 3GPP connection, a non-3GPP connection, an ideal link, a UE aggregation connection, an L2 relay connection, a WLAN connection, or a Bluetooth connection between the remote UE 806 and the relay UE 802.

At 814, the network node 804 may determine a configuration for the remote UE 806 and the relay UE 804 based on (e.g., corresponding to) the UE-UE link information received at 812. For example, the configuration may be in accordance with the user plane architecture configuration described above with reference to 6A or the user plane architecture configuration described above with reference to 6B depending on the determined UE-UE link type of UE-UE link 808.

At 816, the network node may provide (e.g., transmits) the configuration determined for the relay UE 802 to the relay UE 802. At 818, the network node 804 may provide the configuration determined for the remote UE 806 to the remote UE 806 It is noted that the network node 804 may transmit the configuration for the relay UE 802 before, after, or simultaneous with transmitting the configuration for the remote UE 806.

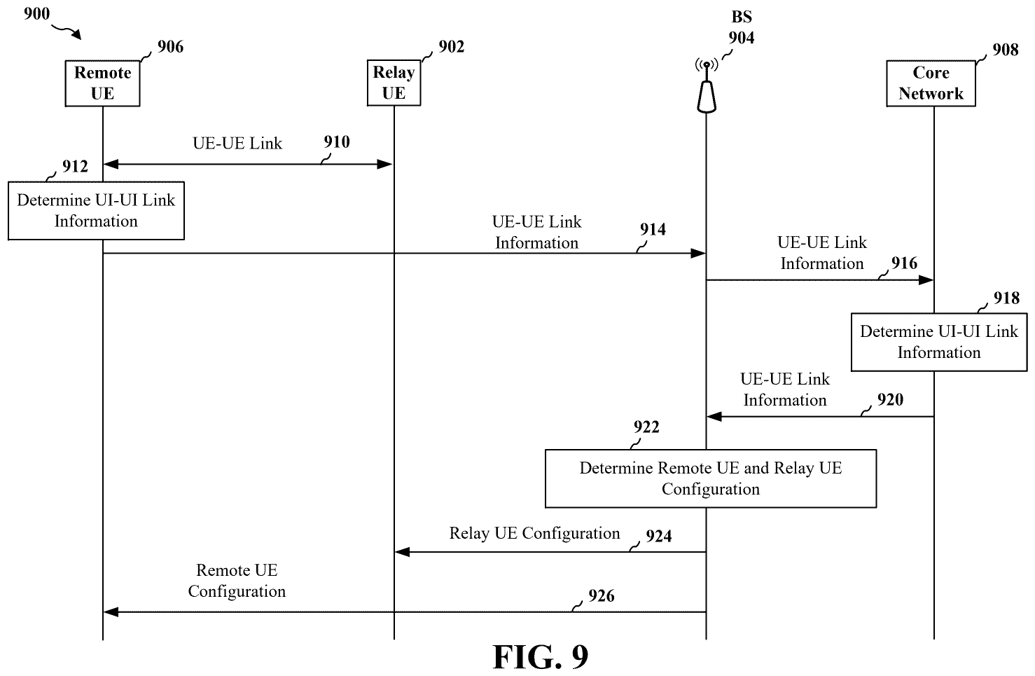

FIG. 9 is a call flow diagram 900 illustrating a method of wireless communication in accordance with various aspects of the present disclosure. In particular, call flow diagram 900 illustrates a core network 908 informing a network node 904 information associated with a UE-UE link 910 between a remote UE 906 and a relay UE 902. The relay UE 902 may be a UE that relays data from the network node 904 to another UE (e.g., a UE that is outside the coverage area of the network node 904 The remote UE 906 may be a UE that 904 data from another UE (e.g., the relay UE 902) and/or the network node 904 (depending on whether the remote UE 906 is within the coverage area of the network node 904). Although aspects are described for the network node 904, the aspects may be performed by a network node in aggregation and/or by one or more components of a network node 904 (e.g., such as a CU 110, a DU 130, and/or an RU 140). As shown in FIG. 9, the remote UE 906 may, at 912, may determine UE-UE link information indicating a UE-UE link type (e.g., for UE-UE link 910) between the remote UE 906 and the relay UE 902. The UE-UE link information may indicate various information associated with the link between the relay UE 902 and the remote UE 906. For instance, the UE-UE link information may indicate the type of UE-UE link established between the relay UE 902 and the remote UE 906.

In one aspect, the remote UE 906 may determine the UE-UE link type based on at least one of whether the remote UE 906 supports a corresponding UE-UE link type, whether the remote UE 906 supports an MP relay for a corresponding UE-UE link type, whether the remote UE 906 is subscribed or authorized with a corresponding UE-UE link type, whether the remote UE 906 is subscribed or authorized with an MP relay for a corresponding UE-UE link type, or whether the remote UE 906 discovers, is pre-configured, or is connected with the relay UE 904 through a corresponding UE-UE link type.

In one aspect, the remote UE 906 may detect UE-UE link type(s) available between the remote UE 906 and the relay UE 902 based on at least one of whether a UE-UE link quality for a UE-UE link type satisfies a criterion configured for single path relay, whether a UE-UE link quality for a UE-UE link type satisfies a criterion configured for MP relay, or whether a UE-UE link for a UE-UE link type is available based on a capability of the remote UE 906.

At 914, the remote UE 906 may transmit a NAS message including the UE-UE link information, which is received by the network node 904. At 916, the network node 904 may forward the NAS message to the core network 908.

In one aspect, the detected UE-UE link type(s) described above are indicated in the UE-UE link information transmitted to the core network 908.

In one aspect, the UE-UE link information transmitted at 914 may include information associated with at least one of a sidelink connection, a PC5 interface, a 3GPP connection, a non-3GPP connection, an ideal link, a UE aggregation connection, an L2 relay connection, a WLAN connection, or a Bluetooth connection between the remote UE 906 and the relay UE 904.

At 918, the core network 908 may determine the UE-UE link information from the NAS message received at 916. It is noted that in other aspects, rather than obtaining the UE-UE link information via a NAS message (as described above), the core network 908 may receive the UE-UE link information based on subscription information (e.g., maintained by the core network 908) for each of the remote UE 906 and the relay UE 902

At 920, the core network 908 may provide the UE-UE link information to the network node 904. In one aspect, the core network 908 may provide the UE-UE link information to the network node 904 through an NGAP message (e.g., through a UE initial context in the NGAP message).

At 922, the network node 904 may determine a configuration for the remote UE 906 and the relay UE 902 based on (e.g., corresponding to) the UE-UE link information received at 920. For example, the configuration may be in accordance with the user plane architecture configuration described above with reference to 6A or the user plane architecture configuration described above with reference to 6B depending on the determined UE-UE link type of UE-UE link 910.

At 924, the network node 904 may provide (e.g., transmits) the configuration determined for the relay UE 902 to the relay UE 902. At 926, the network node 904 may provide the configuration determined for the remote UE 906 to the remote UE 906. It is noted that the network node 904 may transmit the configuration for the relay UE 902 before, after, or simultaneous with transmitting the configuration for the remote UE 906.

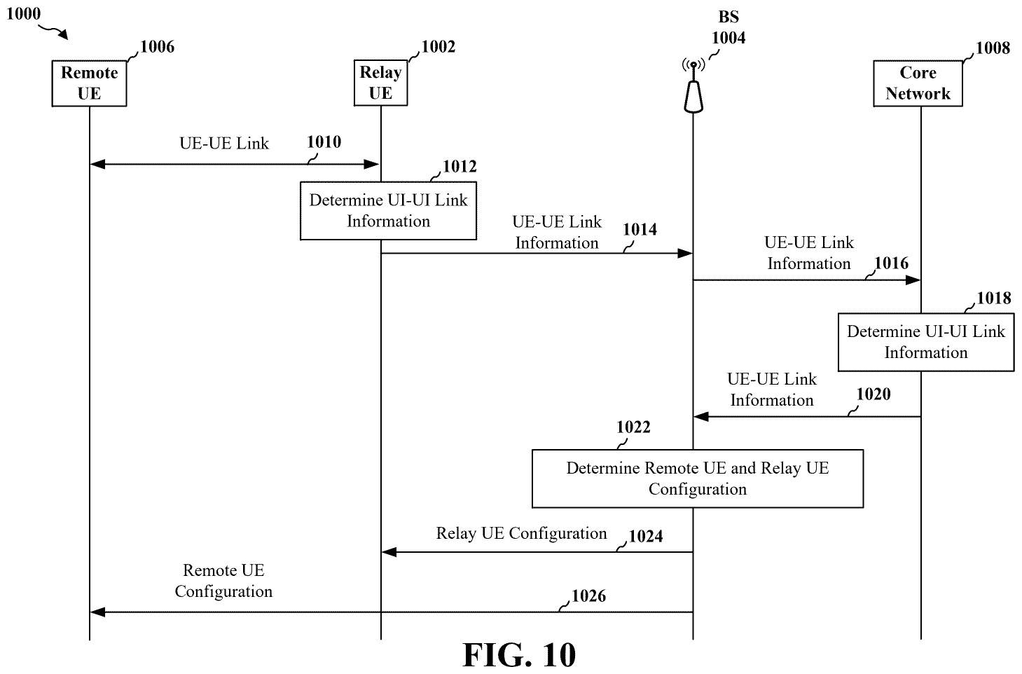

FIG. 10 is a call flow diagram 1000 illustrating a method of wireless communication in accordance with various aspects of the present disclosure. In particular, call flow diagram 1000 illustrates a core network 1008 informing a network node 1004 information associated with a UE-UE link 1010 between a remote UE 1006 and a relay UE 1002. The relay UE 1002 may be a UE that relays data from the network node 1004 to another UE (e.g., a UE that is outside the coverage area of the network node 1004). The remote UE 1006 may be a UE that receives data from another UE (e.g., the relay UE 1002) and/or the network node 1004 (depending on whether the remote UE 1006 is within the coverage area of the network node 1004). Although aspects are described for the network node 1004, the aspects may be performed by a network node in aggregation and/or by one or more components of a network node 1004 (e.g., such as a CU 110, a DU 130, and/or an RU 140). As shown in FIG. 10, the relay UE 1002 may, at 1012, may determine UE-UE link information indicating a UE-UE link type (e.g., for UE-UE link 1010) between the remote UE 1006 and the relay UE 1002. The UE-UE link information may indicate various information associated with the link between the relay UE 1002 and the remote UE 1006. For instance, the UE-UE link information may indicate the type of UE-UE link established between the relay UE 1002 and the remote UE 1006.

In one aspect, the relay UE 1002 may determine the UE-UE link type based on at least one of whether the relay UE 1002 supports a corresponding UE-UE link type, whether the relay UE 1002 is subscribed or authorized with a corresponding UE-UE link type, or whether the relay UE 1002 discovers, is pre-configured, or is connected with the remote UE 1006 through a corresponding UE-UE link type.

In one aspect, the relay UE 1002 may detect UE-UE link type(s) available between the remote UE 1006 and the relay UE 1002 based on at least one of whether a UE-UE link quality for a UE-UE link type satisfies a criterion, or whether a UE-UE link for a UE-UE link type is available based on a capability of the relay UE 1002.

At 1014, the relay UE 1002 may transmit a NAS message including the UE-UE link information, which is received by the network node 1004. At 1016, the network node 1004 may forward the NAS message to the core network 1008.

In one aspect, the detected UE-UE link type(s) described above are indicated in the UE-UE link information transmitted to the core network 1008.

In one aspect, the UE-UE link information transmitted at 1014 may include information associated with at least one of a sidelink connection, a PC5 interface, a 3GPP connection, a non-3GPP connection, an ideal link, a UE aggregation connection, an L2 relay connection, a WLAN connection, or a Bluetooth connection between the remote UE 906 and the relay UE 904.

At 1018, the core network 1008 may determine the UE-UE link information from the NAS message received at 1016. It is noted that in other aspects, rather than obtaining the UE-UE link information via a NAS message (as described above), the core network 1008 may receive the UE-UE link information based on subscription information for each of the remote UE 1006 and the relay UE 1002 (e.g., maintained by the core network 1008).

At 1020, the core network 1008 may provide the UE-UE link information to the network node 1004. In one aspect, the core network 1008 may provide the UE-UE link information to the network node 1004 through an NGAP message (e.g., through a UE initial context in the NGAP message).

At 1022, the network node 1004 may determine a configuration for the remote UE 1006 and the relay UE 1002 based on (e.g., corresponding to) the UE-UE link information received at 1020. For example, the configuration may be in accordance with the user plane architecture configuration described above with reference to 6A or the user plane architecture configuration described above with reference to 6B depending on the determined UE-UE link type of UE-UE link 1010.

At 1024, the network node 1004 may provide (e.g., transmits) the configuration determined for the relay UE 1002 to the relay UE 1002. At 1026, the network node 1004 may provide the configuration determined for the remote UE 1006 to the remote UE 1006. It is noted that the network node 1004 may provide the configuration for the relay UE 1002 before, after, or simultaneous with transmitting the configuration for the remote UE 1006.

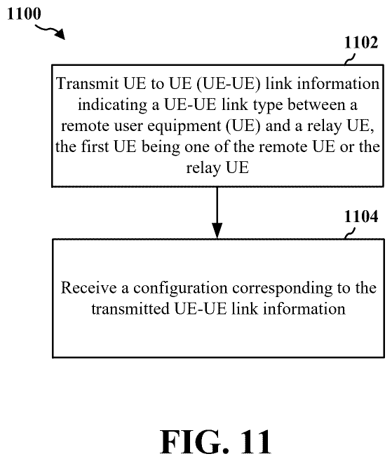

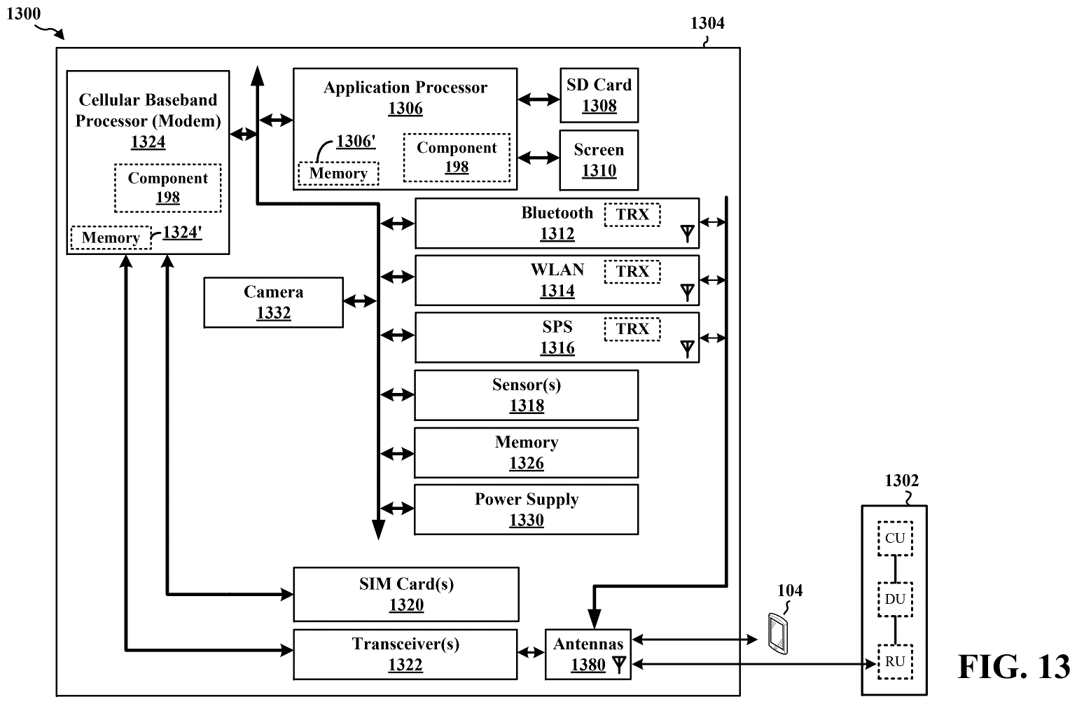

FIG. 11 is a flowchart 1100 illustrating methods of wireless communication at a UE in accordance with various aspects of the present disclosure. The method may be performed by a UE. The UE may be the UE 104, 350, 702, 706, 802, 806, 902, 906, 1002, 1006, or the apparatus 1304 in the hardware implementation of FIG. 13.

As shown in FIG. 11, at 1102, the UE may transmit UE-UE link information indicating a UE-UE link type between a remote UE and a relay UE, the first UE being one of the remote UE or the relay UE. In some aspects, the first UE is the remote UE. For example, referring to FIG. 7, the remote UE 706 may, at 712, transmit UE-UE link information indicating a UE-UE link type (e.g., UE-UE link 708) between the remote UE 706 and the relay UE 702. In some aspects, 1102 may be performed by UE-UE link information determination component 198. In other aspects, the first UE is the relay UE. For example, referring to FIG. 8, the relay UE 802 may, at 812, transmit UE-UE link information indicating a UE-UE link type (e.g., UE-UE link 808) between the remote UE 806 and the relay UE 802.

In some aspects, the UE-UE link information is transmitted through an RRC message. For example, referring to FIGS. 7 and 8, the UE-UE link information transmitted at 712 or 812 may be transmitted through an RRC message.

In some aspects, the UE-UE link information is transmitted in a sidelink UE information NR message, a measurement report, or an MSG5 message. For example, referring to FIGS. 7 and 8, the UE-UE link information transmitted at 712 or 812 may be transmitted in a sidelink UE information NR message, a measurement report, or an MSG5 message.

In some aspects, the transmitted UE-UE link information includes information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE and the relay UE. For example, referring to FIGS. 7 and 8, the UE-UE link information transmitted at 712 or 812 includes information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE (e.g., the remote UE 706 or 806) and the relay UE (e.g., the relay UE 702 or 802).

In some aspects in which the first UE is a remote UE, the remote UE may determine the UE-UE link type based on at least one of whether the remote UE supports a corresponding UE-UE link type, whether the remote UE supports a multipath (MP) relay for a corresponding UE-UE link type, whether the remote UE is subscribed or authorized with a corresponding UE-UE link type, whether the remote UE is subscribed or authorized with an MP relay for a corresponding UE-UE link type, or whether the remote UE discovers, is pre-configured, or is connected with the relay UE through a corresponding UE-UE link type. For example, referring to FIG. 7, the remote UE 706 may determine the UE-UE link type based on at least one of whether the remote UE 706 supports a corresponding UE-UE link type, whether the remote UE 706 supports a multipath (MP) relay for a corresponding UE-UE link type, whether the remote UE 706 is subscribed or authorized with a corresponding UE-UE link type, whether the remote UE 706 is subscribed or authorized with an MP relay for a corresponding UE-UE link type, or whether the remote UE 706 discovers, is pre-configured, or is connected with the relay UE 702 through a corresponding UE-UE link type. The UE-UE link type indicated in the UE-UE link information may be the determined UE-UE link type. For example, referring to FIG. 7, the UE-UE link type indicated in the UE-UE link information transmitted at 712 may be the determined UE-UE link type.

In some aspects in which the first UE is a remote UE, the remote UE may detect one or more UE-UE link types available between the first UE and the relay UE based on at least one of whether a UE-UE link quality for a UE-UE link type satisfies a criterion configured for single path relay, whether a UE-UE link quality for a UE-UE link type satisfies a criterion configured for MP relay, or whether a UE-UE link for a UE-UE link type is available based on a capability of the first UE. For example, referring to FIG. 7, the remote UE 706 may detect UE-UE link type(s) available between the remote UE 706 and the relay UE 702 based on at least one of whether a UE-UE link quality for a UE-UE link type satisfies a criterion configured for single path relay, whether a UE-UE link quality for a UE-UE link type satisfies a criterion configured for MP relay, or whether a UE-UE link for a UE-UE link type is available based on a capability of the first UE. The UE-UE link type indicated in the UE-UE link information may be the detected UE-UE link type(s). For example, referring to FIG. 7, the UE-UE link type indicated in the UE-UE link information transmitted at 712 may be the detected UE-UE link type(s).

In some aspects in which the first UE is a relay UE, the relay UE may determine the UE-UE link type based on at least one of whether the relay UE supports a corresponding UE-UE link type, whether the relay UE is subscribed or authorized with a corresponding UE-UE link type, or whether the relay UE discovers, is pre-configured, or is connected with the remote UE through a corresponding UE-UE link type. For example, referring to FIG. 8, the relay UE 802 may determine the UE-UE link type based on at least one of whether the relay UE 802 supports a corresponding UE-UE link type, whether the relay UE 802 is subscribed or authorized with a corresponding UE-UE link type, or whether the relay UE 802 discovers, is pre-configured, or is connected with the remote UE 806 through a corresponding UE-UE link type. The UE-UE link type indicated in the UE-UE link information may be the determined UE-UE link type. For example, referring to FIG. 8, the UE-UE link type indicated in the UE-UE link information transmitted at 812 may be the determined UE-UE link type.

In some aspects in which the first UE is a relay UE, the relay UE may detect one or more UE-UE link types available between the first UE and the remote UE based on at least one of whether a UE-UE link quality for a UE-UE link type satisfies a configured criterion, or whether a UE-UE link for a UE-UE link type is available based on a capability of the first UE. For example, referring to FIG. 8, the relay UE 802 may detect UE-UE link type(s) available between the remote UE 806 and the relay UE 802 based on at least one of whether a UE-UE link quality for a UE-UE link type satisfies a configured criterion, or whether a UE-UE link for a UE-UE link type is available based on a capability of the first UE. The UE-UE link type indicated in the UE-UE link information may be the detected UE-UE link type(s). For example, referring to FIG. 8, the UE-UE link type indicated in the UE-UE link information transmitted at 812 may be the detected UE-UE link type(s).

In some aspects, the UE-UE link information may be transmitted to a CN through a NAS message. For example, referring to FIG. 9, in an aspect in which the first UE is a remote UE, the remote UE 906 may transmit the UE-UE link information to the network node 904 through a NAS message, and the network node 904 may forward the NAS message to the core network 908 at 916. In another example, referring to FIG. 10, in an aspect in which the first UE is a relay UE, the relay UE 1002 may transmit the UE-UE link information to the network node 1004 through a NAS message, and the network node 1004 may forward the NAS message to the core network 1008 at 1016.

At 1104, the UE may receive a configuration corresponding to the transmitted UE-UE link information. For example, referring to FIGS. 7 and 9, in an aspect in which the first UE is the remote UE 706 or the remote UE 906, the remote UE 706 or the remote UE 906 receives a configuration therefor from the network node 704 at 718 or the network node 904 at 926. In some aspects, 1104 may be performed by UE-UE link information determination component 198. In another example, referring to FIGS. 8 and 10, in an aspect in which the first UE is the relay UE 802 or the relay UE 1002, the relay UE 802 or the relay UE 1002 receives a configuration therefor from network node 804 at 816 or the network node 1004 at 1024.

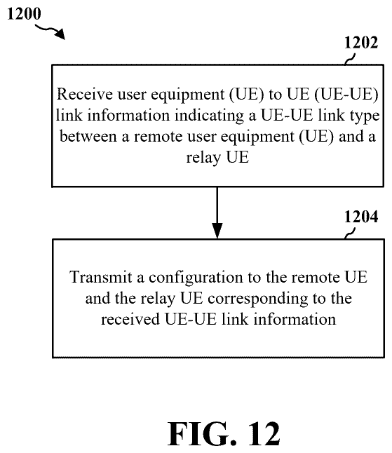

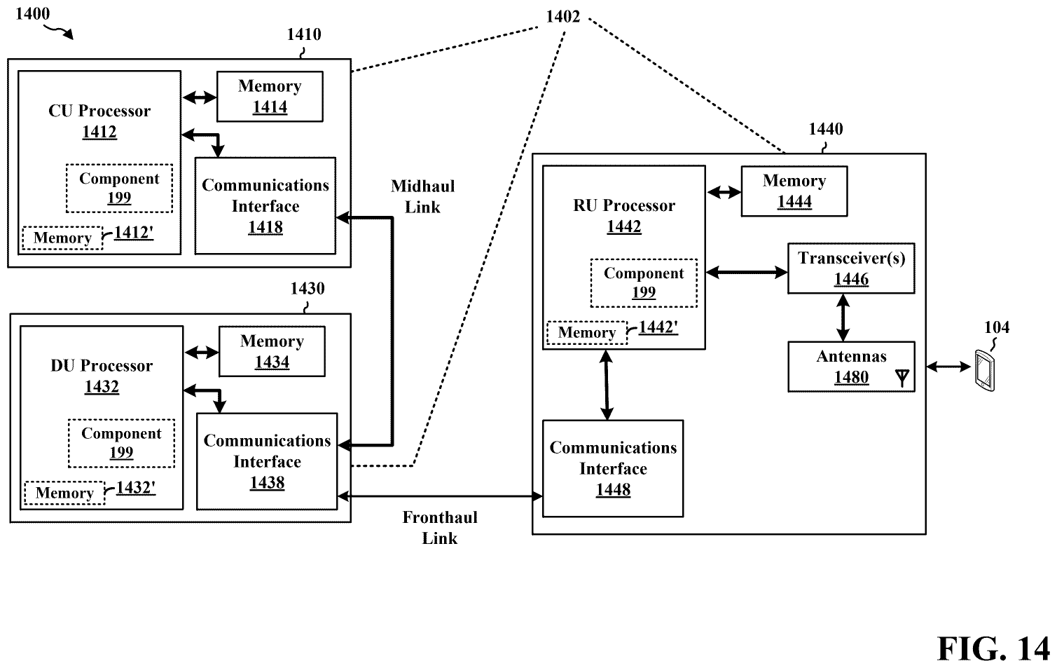

FIG. 12 is a flowchart 1200 illustrating methods of wireless communication at a network node in accordance with various aspects of the present disclosure. The method may be performed by a network node. The network node may be a base station, or a component of a base station, in the access network of FIG. 1 or a core network component (e.g., base station 102, 310; the CU 110, the DU 130; the RU 140; network node 704, 804, 904, or 1004; or the network entity 1402 in the hardware implementation of FIG. 14).

At 1202, the network node may receive UE-UE link information indicating a UE-UE link type between a remote UE and a relay UE. In one aspect, referring to FIG. 7, the network node 704 may receive the UE-UE link information from the remote UE 706 through an RRC message at 712. In some aspects, 1202 may be performed by UE configuration determination component 199. In another aspect, referring to FIG. 8, the network node may receive the UE-UE link information from the relay UE 802 through an RRC message at 812. In a further aspect, the UE-UE link information may be received in a sidelink UE information new radio (NR) message, a measurement report, or an MSG5 message (e.g., from the remote UE 706 at 712 or the relay UE 802 at 812).

In some aspects, the received UE-UE link information includes information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE and the relay UE. For example, referring to FIGS. 7 and 8, the UE-UE link information received at 712 or 812 includes information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE (e.g., the remote UE 706 or 806) and the relay UE (e.g., the relay UE 702 or 802).

In some aspects, the UE-UE link information is received from a CN through a NGAP message. For example, referring to FIGS. 9 and 10, the network node 904 or 1004 may receive the UE-UE link information from the core network 908 or 1008 at 920 or 1020.

In some aspects, the UE-UE link information is received from the CN through a UE initial context in the NGAP message. For example, referring to FIGS. 9 and 10, the UE-UE link information received by the network node 904 or 1004 from the core network 908 or 1008 may be received through a UE initial context in the NGAP message.

In some aspects, the received UE-UE link information is based on subscription information for each of the remote UE and the relay UE. For example, referring to FIGS. 9 and 10, the core network 908 or 1008 may receive the UE-UE link information based on subscription information for each of the remote UE 906 or 1006 and the relay UE 902 or 1002.

In some aspects, the UE-UE link information may be received through a NAS message, and the UE-UE link information received through the NAS message may be forwarded to a CN. For example, referring to FIGS. 9 and 10, the network node 904 or 1004 may receive the UE-UE link information through a NAS message at 914 or 1014, and the network node 904 may forward the NAS message to the core network 908 or 1008 at 916 or 1016.

At 1204, the network node may transmit a configuration to the remote UE and the relay UE corresponding to the received UE-UE link information. In one aspect, referring to FIG. 7, the network node 704 may transmit a configuration to the remote UE and the relay UE corresponding to the received UE-UE link information. In some aspects, 1204 may be performed by UE configuration determination component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to transmit UE-UE link information indicating a UE-UE link type between a remote UE and a relay UE, the first UE being one of the remote UE or the relay UE, and receive a configuration corresponding to the transmitted UE-UE link information. The component 198 may be further configured to perform any of the aspects described in connection with the flowchart of FIG. 13, and/or the aspects performed by the remote UE or the relay UE in the communication flows of FIGS. 7-10. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for transmitting UE-UE link information indicating a UE-UE link type between a remote UE and a relay UE, the first UE being one of the remote UE or the relay UE, and means for receiving a configuration corresponding to the transmitted UE-UE link information. The apparatus may further include means for performing any of the aspects described in connection with the flowchart of FIG. 13, and/or the aspects performed by the remote UE or the relay UE in the communication flows of FIGS. 7-10. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive UE-UE link information indicating a UE-UE link type between a remote UE and a relay UE, and transmit a configuration to the remote UE and the relay UE corresponding to the received UE-UE link information. The component 199 may be further configured to perform any of the aspects described in connection with the flowchart of FIG. 12, and/or the aspects performed by the network node in the communication flows of FIGS. 7-10. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for receiving user equipment UE-UE link information indicating a UE-UE link type between a remote UE and a relay UE and means for transmitting a configuration to the remote UE and the relay UE corresponding to the received UE-UE link information. The component 199 may further include means for performing any of the aspects described in connection with the flowchart of FIG. 12, and/or the aspects performed by the network node in the communication flows of FIGS. 7-10. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Aspects of the present disclosure provide for methods and apparatus for a remote UE or a relay UE to inform a network node of the UE-UE link type being utilized between a remote UE and a relay UE. Using the UE-UE link type, the network node determines a configuration for the remote UE and the relay UE corresponding to the UE-UE link type and provides the determined configuration to the remote UE and the relay UE. The remote UE and the relay UE apply the configuration received from the network node. The methods and apparatus advantageously enable a network node to correctly configure a remote UE and a relay UE for MP relay, thereby enhancing the reliability and throughput of the connection between the UEs and the network node.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including transmitting UE-UE link information indicating a UE-UE link type between a remote UE and a relay UE, the first UE being one of the remote UE or the relay UE.

Aspect 2 is the method of aspect 1, where to transmit the UE-UE link the UE-UE link information is transmitted through an RRC message.

Aspect 3 is the method of any of aspect 1, where the UE-UE link information is transmitted in a sidelink UE information NR message, a measurement report, or an MSG5 message.

Aspect 4 is the method of any of aspects 1 to 3, where the transmitted UE-UE link information includes information associated with at least one of a sidelink connection, a PC5 interface, a 3GPP connection, a non-3GPP connection, an ideal link, a UE aggregation connection, a L2 relay connection, a WLAN connection, or a Bluetooth connection between the remote UE and the relay UE.

Aspect 5 is the method of any of aspects 1 to 4, where the first UE is the remote UE.

Aspect 6 is the method of aspect 5, further including determining the UE-UE link type based on at least one of: whether the remote UE supports a corresponding UE-UE link type; whether the remote UE supports a MP relay for a corresponding UE-UE link type; whether the remote UE is subscribed or authorized with a corresponding UE-UE link type; whether the remote UE is subscribed or authorized with an MP relay for a corresponding UE-UE link type; or whether the remote UE discovers, is pre-configured, or is connected with the relay UE through a corresponding UE-UE link type, where the indicated UE-UE link type is the determined UE-UE link type.

Aspect 7 is the method of any of aspects 5 or 6, further including detecting one or more UE-UE link types available between the first UE and the relay UE based on at least one of: whether a UE-UE link quality for a UE-UE link type satisfies a criterion configured for single path relay; whether a UE-UE link quality for a UE-UE link type satisfies a criterion configured for multipath (MP) relay; or whether a UE-UE link for a UE-UE link type is available based on a capability of the first UE, where the indicated UE-UE link type is one of the detected one or more UE-UE link types.

Aspect 8 is the method of any of aspects 1 to 4, where the first UE is the relay UE.

Aspect 9 is the method of aspect 8, further including determining the UE-UE link type based on at least one of: whether the relay UE supports a corresponding UE-UE link type; whether the relay UE is subscribed or authorized with a corresponding UE-UE link type; or whether the relay UE discovers, is pre-configured, or is connected with the remote UE through a corresponding UE-UE link type, where the indicated UE-UE link type is the determined UE-UE link type.

Aspect 10 is the method of any of aspects 8 or 9, further including detecting one or more UE-UE link types available between the first UE and the remote UE based on at least one of: whether a UE-UE link quality for a UE-UE link type satisfies a configured criterion; or whether a UE-UE link for a UE-UE link type is available based on a capability of the first UE, where the indicated UE-UE link type is one of the detected one or more UE-UE link types.

Aspect 11 is the method of aspect 1, further including transmitting the UE-UE link information to a core network (CN) through a non-access stratum (NAS) message.

Aspect 12 is a method of wireless communication at a network entity, including receiving UE-UE link information indicating a UE-UE link type between a remote UE and a relay UE; and transmitting a configuration to the remote UE and the relay UE corresponding to the received UE-UE link information.

Aspect 13 is a method of aspect 12, where the UE-UE link information is received from the remote UE through an RRC message.

Aspect 14 is a method of aspect 13, where the UE-UE link information is received from the relay UE through an RRC message.

Aspect 15 is a method of aspect 13, where the UE-UE link information is received in a sidelink UE information NR message, a measurement report, or an MSG5 message.

Aspect 16 is a method of any of aspects 13-15, where the received UE-UE link information includes information associated with at least one of a sidelink connection, a PC5 interface, a 3GPP connection, a non-3GPP connection, an ideal link, a UE aggregation connection, an L2 relay connection, a WLAN connection, or a Bluetooth connection between the remote UE and the relay UE.

Aspect 17 is a method of aspect 12 or 16, where the UE-UE link information is received from a CN through a NGAP message.

Aspect 18 is a method of aspect 17, where the UE-UE link information is received from the CN through a UE initial context in the NGAP message.

Aspect 19 is a method of aspect 17, where the received UE-UE link information is based on subscription information for each of the remote UE and the relay UE.

Aspect 20 is a method of 12 and 17-19, further including receiving the UE-UE link information through a NAS message; and forwarding the UE-UE link information received through the NAS message to a CN.

Aspect 21 is an apparatus for wireless communication at a UE. The apparatus includes memory; and at least one processor coupled to the memory and, based at least in part on information stored in the memory, the at least one processor is configured to implement any of aspects 1 to 11.

Aspect 22 is the apparatus of aspect 21, further including at least one of a transceiver or an antenna coupled to the at least one processor.

Aspect 23 is an apparatus for wireless communication at a network entity. The apparatus includes memory; and at least one processor coupled to the memory and, based at least in part on information stored in the memory, the at least one processor is configured to implement any of aspects 12 to 20.

Aspect 24 is the apparatus of aspect 23, further including at least one of a transceiver or an antenna coupled to the at least one processor.

Aspect 25 is an apparatus for wireless communication including means for implementing any of aspects 1 to 11.

Aspect 26 is an apparatus for wireless communication including means for implementing any of aspects 12 to 20.

Aspect 27 is a computer-readable medium (e.g., a non-transitory computer-readable medium) storing computer executable code, the code when executed by at least one processor causes the at least one processor to implement any of aspects 1 to 11.

Aspect 28 is a computer-readable medium (e.g., a non-transitory computer-readable medium) storing computer executable code, the code when executed by at least one processor causes the at least one processor to implement any of aspects 12 to 20.

1. An apparatus of wireless communication at a first user equipment (UE), comprising:
memory; and
at least one processor coupled to the memory and, based at least in part on information stored in the memory, the at least one processor is configured to:
transmit UE to UE (UE-UE) link information indicating a UE-UE link type between a remote UE and a relay UE, the first UE being one of the remote UE or the relay UE; and
receive a configuration corresponding to the transmitted UE-UE link information.

2. The apparatus of claim 1, wherein to transmit the UE-UE link information, the at least one processor is configured to transmit the UE-UE link information through a radio resource control (RRC) message.

3. The apparatus of claim 1, wherein to transmit the UE-UE link information, the at least one processor is configured to transmit the UE-UE link information in a sidelink UE information new radio (NR) message, a measurement report, or a message 5 (MSG5) message.

4. The apparatus of claim 1, wherein the transmitted UE-UE link information includes first information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE and the relay UE.

5. The apparatus of claim 1, wherein the first UE is the remote UE.

6. The apparatus of claim 5, wherein the at least one processor is further configured to determine the UE-UE link type based on at least one of:
whether the remote UE supports a corresponding UE-UE link type;
whether the remote UE supports a multipath (MP) relay for the corresponding UE-UE link type;
whether the remote UE is subscribed or authorized with the corresponding UE-UE link type;
whether the remote UE is subscribed or authorized with an MP relay for the corresponding UE-UE link type; or
whether the remote UE discovers, is pre-configured, or is connected with the relay UE through the corresponding UE-UE link type,
wherein the indicated UE-UE link type is the determined UE-UE link type.

7. The apparatus of claim 5, where the at least one processor is further configured to detect one or more UE-UE link types available between the first UE and the relay UE based on at least one of:
whether a UE-UE link quality for the UE-UE link type satisfies a first criterion configured for single path relay;
whether the UE-UE link quality for the UE-UE link type satisfies a second criterion configured for multipath (MP) relay; or
whether a UE-UE link for the UE-UE link type is available based on a capability of the first UE,
wherein the indicated UE-UE link type is one of the detected one or more UE-UE link types.

8. The apparatus of claim 1, wherein the first UE is the relay UE.

9. The apparatus of claim 8, wherein the at least one processor is further configured to determine the UE-UE link type based on at least one of:
whether the relay UE supports a corresponding UE-UE link type;
whether the relay UE is subscribed or authorized with the corresponding UE-UE link type; or
whether the relay UE discovers, is pre-configured, or is connected with the remote UE through the corresponding UE-UE link type,
wherein the indicated UE-UE link type is the determined UE-UE link type.

10. The apparatus of claim 8, wherein the at least one processor is further configured to detect one or more UE-UE link types available between the first UE and the remote UE based on at least one of:
whether a UE-UE link quality for the UE-UE link type satisfies a configured criterion; or
whether a UE-UE link for the UE-UE link type is available based on a capability of the first UE,
wherein the indicated UE-UE link type is one of the detected one or more UE-UE link types.

11. The apparatus of claim 1, further comprising at least one of a transceiver or an antenna coupled to the at least one processor, wherein to transmit the UE-UE link information, the at least one processor is configured to transmit the UE-UE link information to a core network (CN) through a non-access stratum (NAS) message via at least one of the transceiver or the antenna.

12. An apparatus of wireless communication at a network entity, comprising:
memory; and
at least one processor coupled to the memory and, based at least in part on information stored in the memory, the at least one processor is configured to:
receive user equipment (UE) to UE (UE-UE) link information indicating a UE-UE link type between a remote UE and a relay UE; and
transmit a configuration to the remote UE and the relay UE corresponding to the received UE-UE link information.

13. The apparatus of claim 12, wherein to receive the UE-UE link information, the at least one processor is configured to receive the UE-UE link information from the remote ULE through a radio resource control (RRC) message.

14. The apparatus of claim 12, wherein to receive the UE-UE link information, the at least one processor is configured to receive the UE-UE link information from the relay ULE through a radio resource control (RRC) message.

15. The apparatus of claim 12, wherein to receive the UE-UE link information, the at least one processor is configured to receive the UE-UE link information in a sidelink UE information new radio (NR) message, a measurement report, or a message 5 (MSG5) message.

16. The apparatus of claim 12, wherein the received UE-UE link information includes first information associated with at least one of a sidelink connection, a PC5 interface, a 3^{rd} generation partnership project (3GPP) connection, a non-3GPP connection, an ideal link, a UE aggregation connection, a layer 2 (L2) relay connection, a wireless local area network (WLAN) connection, or a Bluetooth connection between the remote UE and the relay UE.

17. The apparatus of claim 12, further comprising at least one of a transceiver or an antenna coupled to the at least one processor, wherein to receive the UE-UE link information, the at least one processor is configured to receive the UE-UE link information from a core network (CN) through a next generation (NG) application protocol (NGAP) message via at least one of the transceiver or the antenna.

18. The apparatus of claim 17, wherein to receive the UE-UE link information, the at leastoneprocessorisconfiguredtoreceivetheUE-UElinkinformationfromtheCNthrough a UE initial context in the NGAP message.

19. The apparatus of claim 17, wherein the received UE-UE link information is based on subscription information for each of the remote UE and the relay UE.

20. (canceled)

21. A method of wireless communication at a first user equipment (UE), comprising:
transmitting UE to UE (UE-UE) link information indicating a UE-UE link type between a remote UE and a relay UE, the first UE being one of the remote UE or the relay UE; and
receiving a configuration corresponding to the transmitted UE-UE link information.

22-30. (canceled)
